(19) United States
(12) Patent Application Publication
(10) Pub. No.: US 2026/0240214 A1
(43) Pub. Date: Aug. 20, 2026

(54) CARBOHYDRATE FORMULATIONS FOR HYDRATION

(71) Applicant: Berkley, LLC, Sheridan, WY (US)

(72) Inventors: Nicholas D. Gillitt, Sheridan, WY (US); Bridget Grim, Sheridan, WY (US)

(21) Appl. No.: 19/055,138

(22) Filed: Feb. 17, 2025

Related U.S. Application Data
(60) Provisional application No. 63/758,491, filed on Feb. 14, 2025.

(51) Int. Cl. A23L 33/125; A23L 2/39; A23L 2/56; A23L 2/58; A23L 2/60; A23L 33/15

(52) U.S. Cl. CPC A23L 33/125; A23L 2/39; A23L 2/56; A23L 2/58; A23L 2/60; A23L 33/15

(57) ABSTRACT

Aspects of this disclosure relate to formulations and methods designed to provide both carbohydrates as a fuel source and hydration during exercise. In general, a disclosed formulation consists of a mixture of simple sugars, electrolytes, and an osmolality within an optimal range. The methods described may enable a formulation that supports a sustained, slow release of at least one or more glucose-specific source. This occurs through rapid hydrolysis upon entering the stomach, followed by continued hydrolysis within the stomach, ensuring a steady and continuous supply of fuel.

### FIELD

The present disclosure pertains to beverage osmolality and carbohydrate content and their effects on fueling muscles with carbohydrates.

### BACKGROUND

Athletes require both an adequate carbohydrate supply for energy and effective hydration during exercise. However, these requirements can be at odds with each other, leading to uncertainty regarding the optimal type of product to use. A decline in performance may indicate either diminishing blood glucose levels, resulting in insufficient energy for muscle function, or dehydration, where reduced sweating and rising core temperatures impede performance. Distinguishing between these issues can be challenging due to their overlapping effects.

As the total carbohydrate content of a beverage increases to meet the energy needs of working muscles, the osmolality of the beverage also rises. Typically, elevated osmolality is not problematic until it exceeds approximately 450 mOsm/kg. Beyond this threshold, delayed gastric emptying can occur, which restricts the carbohydrate supply to the muscles and may hinder performance. Furthermore, the optimum osmolality range for hydration, as defined by the World Health Organization, is generally lower than that of beverages formulated solely for fueling. Consequently, beverages designed to provide an effective carbohydrate load often surpass the optimal osmolality for hydration, reducing their overall effectiveness in maintaining fluid balance.

The challenge, therefore, is to optimize both fueling and hydration within a single formulation.

### SUMMARY

Aspects of the disclosure relates to a hydration composition. In some embodiments, the hydration composition comprises at least one or more glucose-specific source in an amount effective to yield a working osmolality of about 200 to about 300 mOsm/kg, and at least one electrolyte, wherein the composition is formulated as a liquid, a powder, a gel, or a concentrate. In some embodiments, the at least one or more glucose-specific source includes any combination of at least one member selected from the group consisting of a first glucose source, a second glucose source, and a third glucose source. In some embodiments, the at least one or more glucose-specific sources is selected from the group consisting of sucrose, maltose, dextrin, maltodextrin, glucose, trehalose, fructo-oligosaccharides, beta-glucan, lactose, dextrose, raffinose, cellobiose, isomaltulose, resistant dextrin, cyclodextrin, indigestible dextrin, glucose polymers, tapioca dextrin, corn dextrin, wheat dextrin, potato dextrin, rice dextrin, or any combination thereof. In some embodiments, the hydration composition further comprises at least one carbohydrate that is not glucose-specific. In some embodiments, the at least one carbohydrate that is not glucose-specific is selected from the group selected from galactose, fructose, trioses, ribose, xylose, arabinose, tagatose, allulose, mannose, rhamnose, inulin, chitosan-oligosaccharides, or a combination thereof. In some embodiments, the at least one or more glucose-specific source is in a ratio from about 5:1 to about 1:5. In some embodiments, the at least one or more glucose-specific source is in a range from about 1% to about 20% (w/v) of the hydration composition. In some embodiments, the at least one electrolyte is selected from the group consisting of sodium, potassium, magnesium, calcium, chloride, phosphate, bicarbonate, sulfate, citrate, lactate, acetate, zinc, iron, copper, manganese, selenium, or any combination thereof. In some embodiments, the hydration composition is a beverage. In some embodiments, the beverage is selected from the group consisting of a sports drink, a fruit juice beverage, an alcoholic beverage, a smoothie, an energy drink, a carbonated soft drink, a flavored water, a tea-based beverage, a coffee-based beverage, a dairy-based beverage, a plant-based milk beverage, a protein shake, a meal replacement drink, a kombucha, a functional health drink, a fermented beverage, a coconut water beverage, a herbal infusion, and a botanical extract beverage. In some embodiments, the hydration composition further comprises at least one flavoring agent, an artificial sweetener, a colorant, a vitamin, a mineral, a preservative, or combinations thereof. In some embodiments, the flavoring agent is selected from the group consisting of vanilla, chocolate, caramel, butterscotch, honey, maple, marshmallow, toffee, brown sugar, graham cracker, strawberry, raspberry, blueberry, blackberry, acai, orange, lemon, lime, grapefruit, tangerine, mango, pineapple, passion fruit, guava, papaya, lychee, dragon fruit, banana, almond, hazelnut, peanut, pistachio, pecan, walnut, macadamia, cinnamon, nutmeg, clove, allspice, ginger, cardamom, chai spice, chamomile, lavender, basil, rosemary, thyme, sage, eucalyptus, lemongrass, peppermint, spearmint, anise, fennel, bergamot, orange blossom, rose, hibiscus, elderflower, jasmine, violet, green tea, black tea, coffee, cola, malt, honeybush, yerba mate, saffron, yuzu, tamarind, fig, date, quince, and mulberry, or combinations thereof. In some embodiments, the artificial sweetener is selected from the group consisting of sucralose, aspartame, saccharin, acesulfame potassium, neotame, stevia, monk fruit extract, erythritol, xylitol, allulose, cyclamate, advantame, maltitol, sorbitol, mannitol, isomalt, lactitol, tagatose, thaumatin, glycyrrhizin, brazzein, miraculin, monatin, dihydrochalcone compounds, or combinations thereof. In some embodiments, the colorant is selected from the group consisting of beet juice powder, turmeric extract, spirulina, annatto, beta-carotene, FD&C Red No. 40, Blue No. 1, Yellow No. 5, FD&C Red No. 3, Blue No. 2, Yellow No. 6, Green No. 3, caramel color, anthocyanins (from grape skin, black carrot, elderberry, red cabbage), chlorophyll, paprika extract, lycopene, lutein, saffron extract, cochineal (carmine), hibiscus extract, iron oxide, titanium dioxide, riboflavin (Vitamin B2), gardenia blue, monascus red (from red yeast rice), phycocyanin (from blue-green algae), norbixin, bixin, carthamus yellow (from safflower), curcumin, copper chlorophyllin, caramelized sugar syrup, and combinations thereof. In some embodiments, the vitamin is selected from the group consisting of vitamin B1 (thiamine), vitamin B2 (riboflavin), vitamin B3 (niacin), vitamin B5 (pantothenic acid), vitamin B6 (pyridoxine), vitamin B12 (cobalamin), biotin (vitamin B7), folic acid (vitamin B9), vitamin C (ascorbic acid), vitamin D (D2 ergocalciferol, D3 cholecalciferol), vitamin E (tocopherols, tocotrienols), vitamin K (K1 phylloquinone, K2 menaquinone), vitamin A (retinol, beta-carotene), choline, inositol, pyrroloquinoline quinone (PQQ), coenzyme Q10 (CoQ10), lutein, zeaxanthin, lycopene, alpha-lipoic acid, N-acetyl cysteine (NAC), and combinations thereof. In some embodiments, the mineral is selected from the group consisting of iron, zinc, copper, selenium, manganese, chromium, iodine, molybdenum, silicone, or combinations thereof. In some embodiments, the preservative is selected from the group consisting of sodium benzoate, potassium sorbate, citric acid, ascorbic acid, ethylenediaminetetraacetic acid (EDTA), sulfur dioxide, rosemary extract, tocopherols, calcium disodium EDTA, sodium metabisulfite, potassium metabisulfite, calcium propionate, sorbic acid, benzoic acid, propionic acid, acetic acid, lactic acid, tartaric acid, fumaric acid, malic acid, gluconic acid, natamycin, nisin, lysozyme, thymol, carvacrol, hexametaphosphate, sodium lactate, glycerol monolaurate, hydrogen peroxide, and combinations thereof. In some embodiments, the first glucose source is glucose, the second glucose source is sucrose, and the third glucose source is dextrin, wherein the glucose is at a ratio of 1:1 with fructose. In some embodiments, the osmolality is in the range from about 210-268 mOsm/kg. In some embodiments, the hydration composition comprises a total carbohydrate content in the range from about 6% to about 8% (w/v).

Aspects of the disclosure relate to a method of providing hydration and fuel to a subject. In some embodiments, the method comprises providing the subject the hydration composition as disclosed herein, wherein, the hydration composition maintains hydration and provides fuel to the subject. In some embodiments, the hydration composition is provided in an amount sufficient to offset the loss of water through sweating. In some embodiments, the hydration composition is formulated to enhance fluid retention and sustain metabolic function in the subject. In some embodiments, the hydration composition provides cellular uptake of fluids and provides immediate and sustained energy to the subject. In some embodiments, the subject is engaged in physical exertion and the hydration composition provides sustained hydration and fuel. In some embodiments, the hydration composition supports prolonged endurance and reduces the risk of dehydration-related fatigue. In some embodiments, the subject is experiencing dehydration due to illness, medical treatment, or environmental factors. In some embodiments, the hydration composition is formulated for personalized use based on the subject's individual athletic performance, medical rehydration, occupational hydration management, and general wellness. In some embodiments, the method further comprises enhancing cellular ATP production efficiency to offset dehydration-induced metabolic slowdown. In some embodiments, the method further comprises enhancing evaporative cooling efficiency by dynamically adjusting hydration intake based on core temperature of the subject. In some embodiments, the method further comprises adjusting intra-muscular pH balance to counteract early dehydration effects on muscle contraction. In some embodiments, the method further comprises enhancing cellular glucose absorption via sodium-glucose co-transport mechanisms. In some embodiments, the method further comprises modulating carbohydrate release based on sweat rate and dehydration severity to sustain energy levels. In some embodiments, the method further comprises adjusting hydration intake dynamically based on body temperature, sweat composition, and exertion levels.

### DETAILED DESCRIPTION

The foregoing and other aspects of the present disclosure will now be described in more detail with respect to the description and methodologies provided herein. This description is not intended to be a detailed catalogue of all the ways in which the embodiments of the present disclosure may be implemented, or of all the features that may be added to the present disclosure. For example, features illustrated with respect to one embodiment may be incorporated into other embodiments, and features illustrated with respect to a particular embodiment may be deleted from that embodiment. In addition, numerous variations and additions to the various embodiments suggested herein, which do not depart from the instant disclosure, will be apparent to those skilled in the art in light of the instant detailed description, figures and claims. Hence, the following specification is intended to illustrate some particular embodiments, and not to exhaustively specify all permutations, combinations and variations thereof.

All patents, patent applications, and other publications, referred to herein are expressly incorporated herein by reference, to the same extent as if each individual publication, patent or patent application is specifically and individually indicated to be incorporated by reference. All documents cited are, in relevant part, incorporated herein by reference in their entireties for the purposes indicated by the context of their citation herein. However, the citation of any document is not to be construed as an admission that it is prior art with respect to the present disclosure.

### Definitions

Unless defined otherwise or the context clearly dictates otherwise, all technical and scientific terms used herein have the same meaning as commonly understood by one of ordinary skill in the art to which this disclosure belongs when read in light of the current disclosure.

The term “about” is used to indicate that numerical values and ranges are approximate rather than exact. “About” means approximately, essentially, or roughly equal to the stated value, and is intended to allow for minor variations that do not detract from the invention's overall characteristics. In many instances, “about” may be understood to allow a deviation of up to ±10% of the stated value, unless a different tolerance is expressly indicated by the context. For example, “about 1” may encompass values from approximately 0.9 to 1.1 or “about 10” may encompass values from approximately 9 to 11. These examples are provided for illustrative purposes only, and the exact tolerance for “about” in any specific context will be determined by the surrounding disclosure.

The term “administering” as used herein has its plain and ordinary meaning as understood in light of the specification and refers to one or more steps that may be taken to introduce carbohydrates to the body of a subject such that the carbohydrates can be readily and efficiently delivered to the tissues in the subject's body during strenuous exercise, moderate exercise, a resting state, or after the conclusion of a fasting period.

The term “carbohydrate” as used herein has its plain and ordinary meaning as understood in light of the specification and refers to a compound made up of one or more monosaccharide units having at least 3 carbon atoms (which can be linear, branched, or cyclic) with an oxygen, nitrogen, or sulfur atom bonded to each carbon atom; or a compound having as a part thereof a carbohydrate moiety made up of one or more monosaccharide units each having at least 3 carbon atoms (which can be linear, branched or cyclic), with an oxygen, nitrogen or sulfur atom bonded to each carbon atom. Representative carbohydrates include sugars (including, for example, mono-, di-, tri-, tetra-, and oligo-saccharides containing from about 4, 5, 6, 7, 8, or 9 monosaccharide units), and polysaccharides such as starches, glycogen, cellulose, and polysaccharide gums. Specific monosaccharides include C5 and above (e.g., C5, C6, C7, or C8) sugars; di- and trisaccharides include sugars having two or three monosaccharide units (e.g., C5, C6, C7, or C8). Non-limiting examples of carbohydrates may include glucose, galactose, sucrose, fructose, maltodextrin, raffinose, stachyose, cyclodextrin, starch, monosaccharides, disaccharides, trisaccharides, tetrasaccharides, oligosaccharides, N-acetylglucosamine, N-acetylgalactosamine, ribose, mannose, xylose, arabinose, maltose, isomaltulose, trehalose, lactose, xylitol, sorbitol, mannitol, maltitol, amylose, pectin, amylopectin, hydrocolloids, dextran, pullulan, chitin, chitosan, inulin, hyaluronic acid, glycogen, cellulose, hemicellulose, polysaccharide gums, fucose, rhamnose, allose, altrose, idose, talose, lyxose, erythrose, threose, sedoheptulose, sorbose, psicose, cellobiose, gentiobiose, turanose, verbascose, melezitose, panose, kestose, nystose, maltotriose, erythritol, arabitol, lactitol, ribitol, glucosamine, galactosamine, neuraminic acid (sialic acid), agar, alginate, carrageenan, galactomannan, xyloglucan, glucomannan, beta-glucans, arabinogalactan, alpha-cyclodextrin, beta-cyclodextrin, gamma-cyclodextrin, chondroitin sulfate, heparin, heparan sulfate, dermatan sulfate, keratan sulfate, lichenin, laminarin, fucoidan, galactan, levan, guar gum, xanthan gum, locust bean gum, gum arabic, tragacanth gum, karaya gum, ghatti gum, or modifications or derivatives thereof, such as such as carboxymethyl cellulose, methylcellulose, ethylcellulose, sulfated polysaccharides (e.g., fucoidan), and phosphorylated carbohydrates. In some embodiments, carbohydrates are the body's primary source of “fuel” or energy.

The term “electrolyte” as used herein has its plain and ordinary meaning as understood in light of the specification and refers to substances that have a natural positive or negative charge when dissolved in water. In the human body, they help regulate chemical reactions and maintain the balance between fluids inside and outside cells. Cations are ions with a positive charge. Anions are ions with a negative charge. Electrolytes used by the body include sodium, magnesium, potassium, calcium, chloride, phosphate, sulfate, citrate, lactate, acetate, copper, zinc, iron, manganese, molybdenum, chromium, selenium, and bicarbonate.

The term “liquid product” as used herein is a beverage formulation comprising water as the primary solvent and one or more functional ingredients. Non-limiting function ingredients include carbohydrate sources, electrolyte salts, vitamins, flavoring agents, and similar additives.

As used herein, the term “mineral” refers to an essential inorganic element that is naturally occurring and required for various physiological functions, including but not limited to enzymatic activity, metabolic regulation, structural support, and antioxidant functions. Minerals, as defined in this application, do not necessarily function as electrolytes and may not contribute to the ionic balance or electrical conductivity within biological systems.

The term “osmolality” as used herein has its plain and ordinary meaning as understood in light of the specification and refers to the concentration of a solution expressed as the total number of solute particles per kilogram. Osmolality is measured in milliosmoles of solute per kilogram of solution.

### Formulations

Aspects of the disclosure relate to hydration composition. In some embodiments, the hydration composition includes at least one or more glucose-specific source in an amount effective to yield a working osmolality of about 200 to about 300 mOsm/kg, and at least one electrolyte. In some embodiments, the hydration composition is formulated as a liquid product. In some embodiments, the hydration composition is formulated as a powder. In some embodiments, the hydration composition is formulated as a concentration. In some embodiments, the hydration composition is formulated as a gel.

In some embodiments, the at least one or more glucose-specific source may include simple sugars, complex carbohydrates, polymeric sugars, or combinations thereof. In some embodiments, the at least one or more glucose-specific source may include any combination of at least one member selected from the group consisting of a first glucose source, a second glucose source, and a third glucose source. In some embodiments, the at least one or more glucose-specific source may include any number of glucose-specific sources. In some embodiments, the at least one or more glucose-specific source may include, but not limited to, sucrose, maltose, dextrin, maltodextrin, glucose, trehalose, fructo-oligosaccharides, beta-glucan, lactose, dextrose, raffinose, cellobiose, isomaltulose, resistant dextrin, cyclodextrin, indigestible dextrin, glucose polymers, tapioca dextrin, corn dextrin, wheat dextrin, potato dextrin, rice dextrin, or any combination thereof. In some embodiments, the hydration composition may include at least one additional carbohydrate that is not glucose-specific. In some embodiments, the at least one carbohydrate that is not-glucose-specific may include, but is not limited to, galactose, fructose, trioses, ribose, xylose, arabinose, tagatose, allulose, mannose, rhamnose, inulin, chitosan-oligosaccharides, or a combination thereof. In some embodiments, the at least one or more glucose-specific source includes 1 to 6 different carbohydrates. In some embodiments, the carbohydrates component of the hydration composition includes 1, 2, 3, 4, 5, or 6 different carbohydrates or ranges including and/or spanning the aforementioned values. In some embodiments, the carbohydrate content of the beverage may include, for example, 1-6, 1-5, 1-3, 2-4, 2-5, 3-5, or 4-5 different carbohydrates. In some embodiments, the 1 to 6 different carbohydrates includes simple sugars and complex carbohydrates. In some embodiments, the 1 to 6 different carbohydrates includes at least one simple sugar, at least one complex carbohydrate, and polymeric sugar. In some embodiments, the at least one or more glucose-specific source includes at least two sugars in a ratio from about 5:1 to about 1:5 in the hydration composition. In some embodiments, the at least one or more glucose-specific source includes at least two sugars in a ratio from about 3:1 to about 1:3 in the hydration composition. In some embodiments, the at least one or more glucose-specific source includes at least two sugars in a ratio from about 2:1 to about 1:2 in the hydration composition. In some embodiments, the at least one or more glucose-specific source includes at least two sugars in a ratio from about 1:1 in the hydration composition. In some embodiments, the at least one or more glucose-specific source may include from about 1% by weight to about 25% by weight of the hydration composition. In some embodiments, the hydration composition may include a range with high and low values independently selected from about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25% by weight of the hydration composition, or ranges including, between, and/or spanning the aforementioned values. In some embodiments, the hydration composition includes at least one or more glucose-specific source from a range in about 1% to 10%. In some embodiments, the hydration composition includes at least one or more glucose-specific sources from a range in about 2% to 9%. In some embodiments, the hydration composition includes at least one or more glucose-specific source from a range in about 3% to 8%. In some embodiments, the hydration composition includes at least one or more glucose-specific source from a range in about 4% to 7%. In some embodiments, the hydration composition includes at least one or more glucose-specific source from a range in about 5% to 10%. In some embodiments, the hydration composition includes at least one or more glucose-specific source from a range in about 6% to 8%. In some embodiments, the at least one or more glucose-specific source includes glucose and fructose at a ratio of 1:1, sucrose, and polymeric dextrin.

In some embodiments, the at least one electrolyte may include, but is not limited to, sodium, potassium, magnesium, calcium, chloride, phosphate, bicarbonate, sulfate, citrate, lactate, acetate, zinc, iron, copper, manganese, selenium, or any combination thereof. In some embodiments, the at least one electrolyte is in an amount from about 0.1% by weight to about 5% by weight of the hydration composition. In some embodiments, the hydration composition may include at least one electrolyte in a range with high and low values independently selected from about 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 3.0%, 3.5%, 4.0%, 4.5%, 5.0% by weight of the hydration composition, or ranges including, between, and/or spanning the aforementioned values. In some embodiments, the at least one electrolyte is in an amount from about 0.3% by weight to about 1% by weight of the hydration composition.

In some embodiments, the hydration composition further includes a flavoring agent. In some embodiments, the flavoring agent is a natural flavoring agent. In some embodiments, the flavoring agent is an artificial flavoring agent. In some embodiments, the flavoring agent includes sweet and dessert flavors. In some embodiments, the sweet and dessert flavors include vanilla, chocolate, caramel, butterscotch, honey, maple, marshmallow, toffee, brown sugar, graham cracker. In some embodiments, the flavoring agent includes fruity flavors. In some embodiments the fruity flavors include berry, (including but not limited to strawberry, raspberry, blueberry, blackberry, acai), citrus (including, but not limited to, orange, peach blood orange, lemon, lime, grapefruit, tangerine), and tropical (including, but not limited to, mango, pineapple, passion fruit, guava, papaya, lychee, dragon fruit, banana). In some embodiments, the fruity flavor is peach blood orange. In some embodiments, the flavoring agent includes nutty flavors. In some embodiments, the nutty flavors include almond, hazelnut, peanut, pistachio, pecan, walnut, and macadamia. In some embodiments, the flavoring agent includes spiced and warm flavors. In some embodiments, spiced and warm flavors include cinnamon, nutmeg, clove, allspice, ginger, cardamom, and chai spice. In some embodiments, the flavoring agent includes herbal and botanical flavors. In some embodiments, the herbal and botanical flavors include herbal extracts (including, but not limited to, chamomile, lavender, basil, rosemary, thyme, sage, eucalyptus, lemongrass), essential oils (including, but not limited to peppermint, spearmint, anise, fennel, bergamot, orange blossom). In some embodiments, the flavoring agent includes floral flavors. In some embodiments, floral flavors include rose, hibiscus, elderflower, jasmine, violet, and lavender. In some embodiments, the flavoring agent includes savory and umami flavors. In some embodiments, the savory and umami flavors include matcha, green tea, black tea, coffee, cola, malt, honeybush, and yerba mate. In some embodiments, the flavoring agent includes exotic and unique flavors. In some embodiments, exotic and unique flavors include saffron, yuzu, tamarind, fig, date, quince, and mulberry. In some embodiments, the flavoring agent is in an amount from about 0.1% by weight to about 5% by weight of the hydration composition. In some embodiments, the hydration composition may include a flavoring agent in a range with high and low values independently selected from about 0.1%, 0.2%, 0.3%, 0.4%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 3.0%, 3.5%, 4.0%, 4.5%, 5.0% by weight of the hydration composition, or ranges including, between, and/or spanning the aforementioned values. In some embodiments, the flavoring agent is in an amount from about 0.5% by weight to about 3.0% by weight of the hydration composition.

In some embodiments, the hydration composition includes a sweetener. In some embodiments, the sweetener is a natural sweetener or an artificial sweetener. In some embodiments, the artificial sweetener may include, but are not limited to, sucralose, aspartame, saccharin, acesulfame potassium, neotame, stevia, monk fruit extract, erythritol, xylitol, allulose, cyclamate, advantame, maltitol, sorbitol, mannitol, isomalt, lactitol, tagatose, thaumatin, glycyrrhizin, brazzein, miraculin, monatin, dihydrochalcone compounds, or combinations thereof. In some embodiments, the artificial sweetener is in an amount from about 0.001% by weight to about 5% by weight of the hydration composition. In some embodiments, the hydration composition may include an artificial sweetener in a range with high and low values independently selected from about 0.001%, 0.002%, 0.003%, 0.004%, 0.005%, 0.006%, 0.007%, 0.008%, 0.009%, 0.010%, 0.05%, 0.1%, 0.5%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 3.0%, 3.5%, 4.0%, 4.5%, 5.0% by weight of the hydration composition, or ranges including, between, and/or spanning the aforementioned values. In some embodiments, the artificial sweetener is in an amount from about 0.05% by weight to about 4.0% by weight of the hydration composition.

In some embodiments, the hydration composition includes a colorant. In some embodiments, the colorant is a natural colorant. In some embodiments, the colorant is a synthetic colorant. In some embodiments, the colorant may include, but are not limited to, beet juice powder, turmeric extract, spirulina, annatto, beta-carotene, FD&C Red No. 40, Blue No. 1, Yellow No. 5, FD&C Red No. 3, Blue No. 2, Yellow No. 6, Green No. 3, caramel color, anthocyanins (from grape skin, black carrot, elderberry, red cabbage), chlorophyll, paprika extract, lycopene, lutein, saffron extract, cochineal (carmine), hibiscus extract, iron oxide, titanium dioxide, riboflavin (Vitamin B2), gardenia blue, monascus red (from red yeast rice), phycocyanin (from blue-green algae), norbixin, bixin, carthamus yellow (from safflower), curcumin, copper chlorophyllin, caramelized sugar syrup, and combinations thereof. In some embodiments, the colorant is in an amount from about 0.001% by weight to about 0.5% by weight of the hydration composition. In some embodiments, the hydration composition may include a colorant in a range with high and low values independently selected from about 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.1%, 0.2%, 0.3%, 0.4%, 0.5%, by weight of the hydration composition, or ranges including, between, and/or spanning the aforementioned values. In some embodiments, the colorant is in an amount from about 0.005% by weight to about 0.05% by weight of the hydration composition.

In some embodiments, the hydration composition includes a vitamin. In some embodiments, the vitamin may include, but is not limited to, vitamin B1 (thiamine), vitamin B2 (riboflavin), vitamin B3 (niacin), vitamin B5 (pantothenic acid), vitamin B6 (pyridoxine), vitamin B12 (cobalamin), biotin (vitamin B7), folic acid (vitamin B9), vitamin C (ascorbic acid), vitamin D (D2 ergocalciferol, D3 cholecalciferol), vitamin E (tocopherols, tocotrienols), vitamin K (K1 phylloquinone, K2 menaquinone), vitamin A (retinol, beta-carotene), choline, inositol, pyrroloquinoline quinone (PQQ), coenzyme Q10 (CoQ10), lutein, zeaxanthin, lycopene, alpha-lipoic acid, N-acetyl cysteine (NAC), and combinations thereof. In some embodiments, the vitamin is in an amount from about 0.001% by weight to about 0.5% by weight of the hydration composition. In some embodiments, the hydration composition may include a vitamin in a range with high and low values independently selected from about 0.001%, 0.002%, 0.003%, 0.004%, 0.005%, 0.006%, 0.007%, 0.008%, 0.009%, 0.01%, 0.02%, 0.03%, 0.04%, 0.05%, 0.06%, 0.07%, 0.08%, 0.09%, 0.1%, 0.2%, 0.3%, 0.4%, 0.5%, by weight of the hydration composition, or ranges including, between, and/or spanning the aforementioned values. In some embodiments, the vitamin is in an amount from about 0.02% by weight to about 0.3% by weight of the hydration composition.

In some embodiments, the hydration composition includes a mineral. In some embodiments, the mineral may include, but is not limited to, iron, zinc, copper, selenium, manganese, chromium, iodine, molybdenum, silicone, or combinations thereof. In some embodiments, the mineral is in an amount from about 1% by weight to about 25% by weight of the hydration composition. In some embodiments, the hydration composition may include a mineral in a range with high and low values independently selected from about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25% by weight of the hydration composition, or ranges including, between, and/or spanning the aforementioned values. In some embodiments, the mineral is in an amount from about 1% by weight to about 5% by weight of the hydration composition.

In some embodiments, the hydration composition includes a preservative. In some embodiments, the preservative is a natural preservative. In some embodiments, the preservative is an artificial preservative. In some embodiments, the preservative may include, but is not limited to, sodium benzoate, potassium sorbate, citric acid, ascorbic acid, ethylenediaminetetraacetic acid (EDTA), sulfur dioxide, rosemary extract, tocopherols, calcium disodium EDTA, sodium metabisulfite, potassium metabisulfite, calcium propionate, sorbic acid, benzoic acid, propionic acid, acetic acid, lactic acid, tartaric acid, fumaric acid, malic acid, gluconic acid, natamycin, nisin, lysozyme, thymol, carvacrol, hexametaphosphate, sodium lactate, glycerol monolaurate, hydrogen peroxide, and combinations thereof. In some embodiments, the preservative is in an amount from about 1% by weight to about 25% by weight of the hydration composition. In some embodiments, the hydration composition may include the preservative with a range with high and low values independently selected from about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25% by weight of the hydration composition, or ranges including, between, and/or spanning the aforementioned values. In some embodiments, the preservative is in an amount from about 1% by weight to about 5% by weight of the hydration composition.

In some embodiments, the hydration composition may be provided as a liquid or a liquid product. In some embodiments, the hydration composition is a beverage. In some embodiments, the hydration composition may be provided as a liquid or a liquid product. In some embodiments, the liquid product is a read-to-drink formulation. In some embodiments, the ready-to-drink formulation includes carbonated and non-carbonated beverages. In some embodiments, the beverage may include, but is not limited to, a sports drink, a fruit juice beverage, an alcoholic beverage, a smoothie, an energy drink, a carbonated soft drink, a flavored water, a tea-based beverage, a coffee-based beverage, a dairy-based beverage, a plant-based milk beverage, a protein shake, a meal replacement drink, a kombucha, a functional health drink, a fermented beverage, a coconut water beverage, a herbal infusion, and a botanical extract beverage.

In some embodiments, the hydration composition has an osmolality in the range from about 100 to about 400 mOsm/kg. In some embodiments, the osmolality of the hydration composition may be about 150 mOsm/kg, 175 mOsm/kg, 200 mOsm/kg, 225 mOsm/kg, 250 mOsm/kg, 275 mOsm/kg, 300 mOsm/kg, 325 mOsm/kg, 350 mOsm/kg, 375 mOsm/kg, 400 mOsm/kg, or ranges including and/or spanning the aforementioned values. In some embodiments, the osmolality of the hydration composition is in a range from about 200 to about 300 mOsm/kg. In some embodiments, the osmolality of the hydration composition is in a range from about 200 to about 275 mOsm/kg. In some embodiments, the osmolality of the hydration composition is in a range from about 210 to about 268 mOsm/kg. In some embodiments, the osmolality of the hydration composition is in a range from about 225 to about 250 mOsm/kg. In some embodiments, the hydration composition is not hyperosmotic (>450 mOsm/kg).

In some embodiments, the hydration composition is formulated to ensure that the total carbohydrate content and electrolyte content is sufficient to offset the loss of sweating of the subject that is provided with the hydration composition. In some embodiments, the hydration composition is formulated to provide a sustained slow-release to provide a steady stream of fuel to the subject while concomitantly maintaining the osmolality level for optimal hydration by enhancing the retention of the liquid water in the hydration composition.

In some embodiments, the hydration composition is formulated as a concentrate composition comprising the compounds described herein. Suitable concentrate compositions include, but are not limited to, syrups, flavor packets, and flavor enhancer drops. In some embodiments, full-strength beverages may be prepared by adding the concentrate to a desired amount of water to achieve a target osmolality.

In some embodiments, the concentrate composition includes at least one glucose-specific source in an amount effective to yield a working osmolality of about 200 to about 275 mOsm/kg, and at least one electrolyte. In some embodiments, the concentrate composition further includes a thickening agent.

In some embodiments, the hydration composition is formulated as a powder or granule composition. In other embodiments, the hydration composition is formulated as a dry-blend formulation. Powdered beverages may be prepared by dry-mixing all of the beverage ingredients in the absence of a liquid matrix. In some embodiments, full-strength beverages may be prepared by adding water to the powdered composition to achieve the desired osmolality.

In some embodiments, the powdered composition may be in the form of a tablet or an easy-to-dissolve dry mix. In other embodiments, the powdered composition may require blending into water to achieve the desired osmolality.

In some embodiments, the hydration composition is formulated as a gel. In certain embodiments, the gel includes a gelling ingredient. As used herein, the term “gelling ingredient” refers to any material capable of forming a colloidal system within a liquid medium. Non-limiting examples of gelling ingredients include gelatin, alginate, carrageenan, gum, pectin, konjac, agar, food acid, rennet, starch, starch derivatives, and combinations thereof. The amount of gelling ingredient used in an edible gel composition may vary depending on factors such as the specific gelling ingredient selected, the fluid base employed, and the desired properties of the gel. In some embodiments, the hydration composition is formulated as an edible gel composition. Edible gels, as described herein, are gels that can be consumed. A gel is a colloidal system in which a network of particles spans the volume of a liquid medium. Although gels are primarily composed of liquids and exhibit densities similar to liquids, they possess the structural coherence of solids due to the network of particles within the medium. As a result, gels generally appear as solid, jelly-like materials. Gels can be used in a variety of applications, including foods, paints, and adhesives. Non-limiting examples of edible gel compositions include gel desserts, puddings, jellies, pastes, trifles, aspics, marshmallows, gummy candies, and similar products. Edible gel mixes are typically powdered or granular solids to which a fluid may be added to form an edible gel composition.

### Methods and Uses

Aspects of the disclosure relate to providing hydration and fuel to a subject. In some embodiments, the method includes providing a subject the hydration composition as disclosed herein wherein, the hydration composition maintains hydration and provides fuel to the subject. In some embodiments, the hydration composition is provided in an amount sufficient to offset the loss of water through sweating. In some embodiments, the hydration composition is formulated to enhance fluid retention and sustain metabolic function in the subject. In some embodiments, the hydration composition provides cellular uptake of fluids and provides immediate and sustained energy to the subject. In some embodiments, the subject is engaged in physical exertion and the hydration composition provides sustained hydration and fuel. In some embodiments, the hydration composition supports prolonged endurance and reduces the risk of dehydration-related fatigue. In some embodiments, the subject is experiencing dehydration due to illness, medical treatment, or environmental factors. In some embodiments, the hydration composition is formulated for personalized use based on the subject's individual athletic performance, medical rehydration, occupational hydration management, and general wellness. In some embodiments, the method includes enhancing cellular ATP production efficiency to offset dehydration-induced metabolic slowdown. In some embodiments, the method includes enhancing evaporative cooling efficiency by dynamically adjusting hydration intake based on core temperature of the subject. In some embodiments, the method includes adjusting intra-muscular pH balance to counteract early dehydration effects on muscle contraction. In some embodiments, the method includes enhancing cellular glucose absorption via sodium-glucose co-transport mechanisms. In some embodiments, the method includes modulating carbohydrate release based on sweat rate and dehydration severity to sustain energy levels. In some embodiments, the method includes adjusting hydration intake dynamically based on body temperature, sweat composition, and exertion levels.

Some embodiments relate to a method of providing sustained energy to a subject. In some embodiments, the method includes providing a hydration composition as described herein to a subject. In some embodiments, the hydration composition includes a first glucose source, a second glucose source, and/or a third glucose source in an amount effective to yield a working osmolality of about 200 to about 300 mOsm/kg, and at least one electrolyte, wherein the first glucose source is glucose, the second glucose source is sucrose, and the third glucose source is dextrin. In some embodiments, the hydration composition further comprises sucrose. In some embodiments, the glucose and fructose are in a ratio of about 1:1. In some embodiments, the first glucose source, the second glucose source, the third glucose source, and fructose comprise about 6% to about 8% (w/v) of the hydration composition. In some embodiments, the hydration composition is formulated for sustained release of glucose initially from the free sugar. In some embodiments, the hydration composition is formulated for the sucrose to be hydrolyzed in the stomach of the subject. In some embodiments, the hydration composition is formulated for the dextrin to be hydrolyzed in the stomach of the subject. In some embodiments, the method includes enhancing cellular ATP production efficiency to offset dehydration-induced metabolic slowdown. In some embodiments, the method includes enhancing evaporative cooling efficiency by dynamically adjusting hydration intake based on core temperature of the subject. In some embodiments, the method includes adjusting intra-muscular pH balance to counteract early dehydration effects on muscle contraction. In some embodiments, the method includes enhancing cellular glucose absorption via sodium-glucose co-transport mechanisms. In some embodiments, the method includes modulating carbohydrate release based on sweat rate and/or dehydration severity to sustain energy levels. In some embodiments, the method includes adjusting hydration intake dynamically based on body temperature, sweat composition, and/or exertion levels. In some embodiments, the method includes enhancing cellular ATP production efficiency to offset dehydration-induced metabolic slowdown. In some embodiments, the method includes enhancing evaporative cooling efficiency by dynamically adjusting hydration intake based on core temperature of the subject. In some embodiments, the method includes adjusting intra-muscular pH balance to counteract early dehydration effects on muscle contraction. In some embodiments, the method includes enhancing cellular glucose absorption via sodium-glucose co-transport mechanisms. In some embodiments, the method includes modulating carbohydrate release based on sweat rate and/or dehydration severity to sustain energy levels. In some embodiments, the method includes adjusting hydration intake dynamically based on body temperature, sweat composition, and/or exertion levels.

Some embodiments relate to a method for maintaining blood glucose levels during dehydration. In some embodiments, the method includes providing a hydration composition as described herein to a subject. In some embodiments, the hydration composition includes a first glucose source, a second glucose source, a third glucose source in an amount effective to yield a working osmolality of about 200 to about 300 mOsm/kg, and at least one electrolyte, wherein the first glucose source is glucose, the second glucose source is sucrose, and the third glucose source is dextrin. In some embodiments, the hydration composition further comprises sucrose. In some embodiments, the glucose and fructose are in a ratio of about 1:1. In some embodiments, the first glucose source, the second glucose source, the third glucose source, and fructose comprise about 6% to about 8% (w/v) of the hydration composition. In some embodiments, the hydration composition is formulated for sustained release of glucose initially from the free sugar. In some embodiments, the hydration composition is formulated for the sucrose to be hydrolyzed in the stomach of the subject. In some embodiments, the hydration composition is formulated for the dextrin to be hydrolyzed in the stomach of the subject. In some embodiments, the method includes enhancing cellular ATP production efficiency to offset dehydration-induced metabolic slowdown. In some embodiments, the method includes enhancing evaporative cooling efficiency by dynamically adjusting hydration intake based on core temperature of the subject. In some embodiments, the method includes adjusting intra-muscular pH balance to counteract early dehydration effects on muscle contraction. In some embodiments, the method includes enhancing cellular glucose absorption via sodium-glucose co-transport mechanisms. In some embodiments, the method includes modulating carbohydrate release based on sweat rate and/or dehydration severity to sustain energy levels. In some embodiments, the method includes adjusting hydration intake dynamically based on body temperature, sweat composition, and/or exertion levels.

Some embodiments relate to a method for maintaining muscle function during early-stage dehydration. In some embodiments, the method includes providing a hydration composition as described herein to a subject. In some embodiments, the hydration composition includes a first glucose source, a second glucose source, a third glucose source in an amount effective to yield a working osmolality of about 200 to about 300 mOsm/kg, and at least one electrolyte, wherein the first glucose source is glucose, the second glucose source is sucrose, and the third glucose source is dextrin. In some embodiments, the hydration composition further comprises sucrose. In some embodiments, the glucose and fructose are in a ratio of about 1:1. In some embodiments, the first glucose source, the second glucose source, the third glucose source, and fructose comprise about 6% to about 8% (w/v) of the hydration composition. In some embodiments, the hydration composition is formulated for sustained release of glucose initially from the free sugar. In some embodiments, the hydration composition is formulated for the sucrose to be hydrolyzed in the stomach of the subject. In some embodiments, the hydration composition is formulated for the dextrin to be hydrolyzed in the stomach of the subject. In some embodiments, the hydration composition provides an extended-release hydration solution to optimize muscle endurance. In some embodiments, the method includes enhancing cellular ATP production efficiency to offset dehydration-induced metabolic slowdown. In some embodiments, the method includes enhancing evaporative cooling efficiency by dynamically adjusting hydration intake based on core temperature of the subject. In some embodiments, the method includes adjusting intra-muscular pH balance to counteract early dehydration effects on muscle contraction. In some embodiments, the method includes enhancing cellular glucose absorption via sodium-glucose co-transport mechanisms. In some embodiments, the method includes modulating carbohydrate release based on sweat rate and/or dehydration severity to sustain energy levels. In some embodiments, the method includes adjusting hydration intake dynamically based on body temperature, sweat composition, and/or exertion levels.

Some embodiments of the disclosure relate to a method of providing an optimal hydration and fueling to a subject. In some embodiments, the method includes providing a subject the hydration composition as disclosed herein wherein, the hydration composition provides optimal hydration and fueling to the subject. In some embodiments, hydration composition is calibrated to an osmolality range that provides an optimized benefit from the at least one or more glucose-specific source in the hydration composition as described herein. In some embodiments, the hydration composition provides both an optimal fuel and optimal hydration level. In some embodiments, providing the hydration composition maximizes absorption and oxidation rates during exercise. In some embodiments, providing the hydration composition maintains proper fluid balance and support muscle function. In some embodiments, the hydration composition provides rapid gastric emptying and efficient fluid absorption. In some embodiments, providing the hydration composition aids in effective rehydration and fueling.

### Example 1

This example illustrates a formulation of the disclosure as represented in Table 1.

TABLE 1

| Formula | Amount | |
|---|---|---|
| Carbohydrate Mixture (Glucose:Fructose | 6%-8% | (w/v) |
| (1:1), Sucrose, Dextrin) | | |
| Electrolytes | 0.3%-1% | (w/v) |
| Flavoring Agent | 0.5%-3.0% | (w/v) |
| Colorant | 0.005%-0.05% | (w/v) |
| Water | 88%-93% | (w/v) |
| Osmolality | 210-268 | mOsm/kg |

In this example, the formulation was optimized to counteract fluid loss due to sweating while providing a sustained, slow release of glucose to support exercising muscles. This was achieved by incorporating three distinct carbohydrate sources that release glucose at different rates, while simultaneously maintaining a specific osmolality that enhances water retention in the beverage. The formulation was developed by adjusting the carbohydrate profile to attain the target osmolality, accomplished by strategically combining free glucose, sucrose, and dextrin. Without wishing to be bound by theory, it is believed that free glucose offers an immediate source of energy upon ingestion, sucrose undergoes rapid hydrolysis in the stomach to release glucose with a slight delay, and polymeric dextrin is slowly hydrolyzed to provide a gradual release of glucose. The staggered release from these sources ensures a continuous supply of energy to the muscles during exercise. Moreover, this specific combination was essential for achieving the desired osmolality: using only glucose and/or sucrose may yield an osmolality that is too high, while relying solely on dextrin may result in an osmolality that is too low. Thus, the particular combination, or any equivalent combination of glucose-specific sources in varying ratios, provided a desired working osmolality within the desired range.

### Example 2

This example illustrates a formulation of the disclosure prepared as a powder formulation as represented in Table 2.

TABLE 2
Powder Formulation (Per Serving for 500 mL of Water)

| Ingredient | Amount (per serving) | |
|---|---|---|
| Carbohydrate Mixture (Glucose:Fructose (1:1), | 30-40 g (to achieve | |
| Sucrose, Dextrin) | 6-8% concentration) | |
| Electrolytes | 0.26-0.56 | g |
| Flavoring Agent | 0.25-0.5 | g |
| Colorant | 0.05-0.25 | g |

The formulation described in this example may be mixed with a liquid, such as with water, according to the instructions provided, to create hydration compositions as described herein. A serving of the powder formulation is mixed sufficiently to yield a final osmolality of 210-268 mOsm/kg.

### Example 3

This example illustrates a formulation of the disclosure prepared as a gel formulation as represented in Table 3.

TABLE 3
Gel Formulation (Per Serving for 500 mL of Water)

| Ingredient | Amount (per serving) | |
|---|---|---|
| Carbohydrate Mixture (Glucose:Fructose (1:1), | 30-40 g (to achieve | |
| Sucrose, Dextrin) | 6-8% concentration) | |
| Electrolytes | 0.26-0.56 | g |
| Flavoring Agent | 0.25-0.5 | g |
| Colorant | 0.05-0.25 | g |
| Thickening Agent | 1-2 | g |
| Preservative | 0.1-0.3 | g |
| Water | 20-40 | ml |

The formulation described in this example may be mixed with a liquid, such as with water, according to the instructions provided, to create hydration compositions as described herein. A serving of the gel formulation is mixed sufficiently to yield a final osmolality of 210-268 mOsm/kg.

### Example 4

This example illustrates a formulation of the disclosure prepared as a concentrate formulation as represented in Table 4.

TABLE 4
Concentration Formulation (Per Serving for 500 mL of Water)

| Ingredient | Amount (per serving) | |
|---|---|---|
| Carbohydrate Mixture (Glucose:Fructose | 50-60 g (to achieve | |
| (1:1), Sucrose, Dextrin) | 6-8% concentration) | |
| Electrolytes | 0.5-0.7 | g |
| Flavoring Agent | 0.5-1.0 | g |
| Colorant | 0.1-0.5 | g |
| Preservative | 0.2-0.6 | g |
| Water | 20-100 | ml |

A serving of the concentrate formulation is mixed sufficiently to yield a final osmolality of 210-268 mOsm/kg.

### Example 5

This example illustrates use of the formulations described herein. The formulations may be prepared as described herein, and ingested by a subject. The subject is anticipated to be a subject as described herein, including a subject having dehydration or susceptible to dehydration, including for example, a subject that is dehydrated or susceptible to loss of water through exertion, a subject having an illness, a subject having medical treatment, or otherwise experiencing or capable of experiencing dehydration. The subject may include a subject in need of sustained energy, a subject in need of maintaining blood glucose levels during dehydration, and/or a subject in need of maintaining muscle function.

The formulations described herein are expected to be formulated and ingested by the subject. The formulations may potentially be ingested multiple times a day, such as 2 times daily, 3 times daily, 4 times daily, 5 times daily, 6 times daily, 7 times daily, 8 times daily, 9 times daily, or 10 times daily, or more as needed or desired by the subject. The formulations could be ingested once daily, once every two days, once every three days, once every four days, once every five days, once every six days, once weekly, once every two weeks, once every three weeks, once every four weeks, once monthly, or at a frequency as needed or desired by the subject.

In this example, the recommended dosage amount that will be provided to the subjects will range from 250 mL to 500 mL per ingestion, depending on the subject's hydration needs and activity levels. For subjects engaged in high-intensity exertion, ingestion of up to 1 liter per session may be appropriate.

The formulations are anticipated to exhibit stability under standard storage conditions, with a shelf life of at least 12 months when stored in a cool, dry environment. Formulations in powder form may retain stability for up to 24 months, while gel and concentrate forms are expected to maintain efficacy for at least 18 months when kept in sealed containers at room temperature.

It is anticipated that the ingestion of the formulations will result in superior outcomes of increased hydration, increased energy, increased retention of liquid, improved health, improved well-being, maintained blood glucose levels, and/or increased muscle function, as compared to subjects not ingesting the formulation, or in comparison to subjects ingesting beverages lacking hydration and fuel components as formulated in the embodiments described herein.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments can be understood and effected by those skilled in the art in practicing the claimed disclosure, from a study of the drawings, the disclosure and the appended claims.

All references cited herein are incorporated herein by reference in their entirety. To the extent publications and patents or patent applications incorporated by reference contradict the disclosure contained in the specification, the specification is intended to supersede and/or take precedence over any such contradictory material.

Unless otherwise defined, all terms (including technical and scientific terms) are to be given their ordinary and customary meaning to a person of ordinary skill in the art, and are not to be limited to a special or customized meaning unless expressly so defined herein. It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term ‘including’ should be read to mean ‘including, without limitation,’ ‘including but not limited to,’ or the like; the term ‘comprising’ as used herein is synonymous with ‘including,’ ‘containing,’ or ‘characterized by,’ and is inclusive or open-ended and does not exclude additional, unrecited elements or method steps; the term ‘having’ should be interpreted as ‘having at least;’ the term ‘includes’ should be interpreted as ‘includes but is not limited to;’ the term ‘example’ is used to provide exemplary instances of the item in discussion, not an exhaustive or limiting list thereof; adjectives such as ‘known’, ‘normal’, ‘standard’, and terms of similar meaning should not be construed as limiting the item described to a given time period or to an item available as of a given time, but instead should be read to encompass known, normal, or standard technologies that may be available or known now or at any time in the future; and use of terms like ‘preferably,’ ‘preferred,’ ‘desired,’ or ‘desirable,’ and words of similar meaning should not be understood as implying that certain features are critical, essential, or even important to the structure or function of the invention, but instead as merely intended to highlight alternative or additional features that may or may not be utilized in a particular embodiment of the invention. Likewise, a group of items linked with the conjunction ‘and’ should not be read as requiring that each and every one of those items be present in the grouping, but rather should be read as ‘and/or’ unless expressly stated otherwise. Similarly, a group of items linked with the conjunction ‘or’ should not be read as requiring mutual exclusivity among that group, but rather should be read as ‘and/or’ unless expressly stated otherwise.

As used in the claims below and throughout this disclosure, by the phrase “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

Where a range of values is provided, it is understood that the upper and lower limit, and each intervening value between the upper and lower limit of the range is encompassed within the embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. The indefinite article “a” or “an” does not exclude a plurality. A single processor or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All numbers expressing quantities of ingredients, reaction conditions, and so forth used in the specification are to be understood as being modified in all instances by the term ‘about.’ Accordingly, unless indicated to the contrary, the numerical parameters set forth herein are approximations that may vary depending upon the desired properties sought to be obtained. At the very least, and not as an attempt to limit the application of the doctrine of equivalents to the scope of any claims in any application claiming priority to the present application, each numerical parameter should be construed in light of the number of significant digits and ordinary rounding approaches.

Furthermore, although the foregoing has been described in some detail by way of illustrations and examples for purposes of clarity and understanding, it is apparent to those skilled in the art that certain changes and modifications may be practiced. Therefore, the description and examples should not be construed as limiting the scope of the invention to the specific embodiments and examples described herein, but rather to also cover all modification and alternatives coming with the true scope and spirit of the invention.

1. A hydration composition, comprising:
at least one or more glucose-specific source comprising free glucose, sucrose, and a polymeric dextrin in an amount effective to yield a working osmolality of about 200 to about 300 mOsm/kg; and
at least one electrolyte,
wherein the hydration composition is formulated as a liquid, a powder, a gel, or a concentrate,
wherein the polymeric dextrin is provided at an amount sufficient to provide a sustained release of energy while maintaining the working osmolality level that promotes optimal hydration,
wherein the polymeric dextrin is a carbohydrate comprising a plurality of monosaccharide units which can be linear, branched, or cyclic, and
wherein the polymeric dextrin is selected from the group consisting of a resistant dextrin, an indigestible dextrin, tapioca dextrin, corn dextrin, wheat dextrin, potato dextrin, rice dextrin, polymeric dextrins comprising cyclic monosaccharide units, and modifications or derivatives thereof,
wherein the hydration composition has a total carbohydrate content in the range of about 6% to about 8% (w/v).

2. The hydration composition of claim 1, wherein the at least one or more glucose-specific source further comprises a glucose and a fructose, wherein the glucose and the fructose are in a ratio from about 3:1 to about 1:3.

3. The hydration composition of claim 1, wherein the polymeric dextrin comprises a plurality of monosaccharide units each having at least 3 carbon atoms branched with an oxygen, nitrogen, or sulfur atom bonded to each carbon atom.

4. The hydration composition of claim 1, further comprising at least one carbohydrate that is not glucose-specific.

5. The hydration composition of claim 4, wherein the at least one carbohydrate that is not glucose-specific is selected from the group selected from galactose, fructose, trioses, ribose, xylose, arabinose, tagatose, allulose, mannose, rhamnose, inulin, chitosan-oligosaccharides, or a combination thereof.

6. The hydration composition of claim 4, wherein the at least one or more glucose-specific source and the at least one carbohydrate that is not glucose-specific is in a ratio from about 5:1 to about 1:5.

7. The hydration composition of claim 1, wherein the at least one or more glucose-specific source is in a range from about 1% to about 20% (w/v) of the hydration composition.

8. The hydration composition of claim 1, wherein the at least one electrolyte is selected from the group consisting of sodium, potassium, magnesium, calcium, chloride, phosphate, bicarbonate, sulfate, citrate, lactate, acetate, zinc, iron, copper, manganese, selenium, or any combination thereof.

9. The hydration composition of claim 1, wherein the liquid is a beverage.

10. The hydration composition of claim 9, wherein the beverage is selected from the group consisting of a sports drink, a fruit juice beverage, an alcoholic beverage, a smoothie, an energy drink, a carbonated soft drink, a flavored water, a tea-based beverage, a coffee-based beverage, a dairy-based beverage, a plant-based milk beverage, a protein shake, a meal replacement drink, a kombucha, a functional health drink, a fermented beverage, a coconut water beverage, a herbal infusion, and a botanical extract beverage.

11. The hydration composition of claim 1, further comprising a flavoring agent, an artificial sweetener, a colorant, a vitamin, a mineral, a preservative, or combinations thereof.

12. The hydration composition of claim 11, wherein the flavoring agent is selected from the group consisting of vanilla, chocolate, caramel, butterscotch, honey, maple, marshmallow, toffee, brown sugar, graham cracker, strawberry, raspberry, blueberry, blackberry, acai, orange, lemon, lime, grapefruit, tangerine, mango, pineapple, passion fruit, guava, papaya, lychee, dragon fruit, banana, almond, hazelnut, peanut, pistachio, pecan, walnut, macadamia, cinnamon, nutmeg, clove, allspice, ginger, cardamom, chai spice, chamomile, lavender, basil, rosemary, thyme, sage, eucalyptus, lemongrass, peppermint, spearmint, anise, fennel, bergamot, orange blossom, rose, hibiscus, elderflower, jasmine, violet, green tea, black tea, coffee, cola, malt, honeybush, yerba mate, saffron, yuzu, tamarind, fig, date, quince, and mulberry, or combinations thereof.

13. The hydration composition of claim 11, wherein the artificial sweetener is selected from the group consisting of sucralose, aspartame, saccharin, acesulfame potassium, neotame, stevia, monk fruit extract, erythritol, xylitol, allulose, cyclamate, advantame, maltitol, sorbitol, mannitol, isomalt, lactitol, tagatose, thaumatin, glycyrrhizin, brazzein, miraculin, monatin, dihydrochalcone compounds, or combinations thereof.

14. The hydration composition of claim 11, wherein the colorant is selected from the group consisting of beet juice powder, turmeric extract, spirulina, annatto, beta-carotene, FD&C Red No. 40, Blue No. 1, Yellow No. 5, FD&C Red No. 3, Blue No. 2, Yellow No. 6, Green No. 3, caramel color, anthocyanins (from grape skin, black carrot, elderberry, red cabbage), chlorophyll, paprika extract, lycopene, lutein, saffron extract, cochineal (carmine), hibiscus extract, iron oxide, titanium dioxide, riboflavin (Vitamin B2), gardenia blue, monascus red (from red yeast rice), phycocyanin (from blue-green algae), norbixin, bixin, carthamus yellow (from safflower), curcumin, copper chlorophyllin, caramelized sugar syrup, and combinations thereof.

15. The hydration composition of claim 11, wherein the vitamin is selected from the group consisting of vitamin B1 (thiamine), vitamin B2 (riboflavin), vitamin B3 (niacin), vitamin B5 (pantothenic acid), vitamin B6 (pyridoxine), vitamin B12 (cobalamin), biotin (vitamin B7), folic acid (vitamin B9), vitamin C (ascorbic acid), vitamin D (D2 ergocalciferol, D3 cholecalciferol), vitamin E (tocopherols, tocotrienols), vitamin K (K1 phylloquinone, K2 menaquinone), vitamin A (retinol, beta-carotene), choline, inositol, pyrroloquinoline quinone (PQQ), coenzyme Q10 (CoQ10), lutein, zeaxanthin, lycopene, alpha-lipoic acid, N-acetyl cysteine (NAC), and combinations thereof.

16. The hydration composition of claim 11, wherein the mineral is selected from the group consisting of iron, zinc, copper, selenium, manganese, chromium, iodine, molybdenum, silicone, or combinations thereof.

17. The hydration composition of claim 11, wherein the preservative is selected from the group consisting of sodium benzoate, potassium sorbate, citric acid, ascorbic acid, ethylenediaminetetraacetic acid (EDTA), sulfur dioxide, rosemary extract, tocopherols, calcium disodium EDTA, sodium metabisulfite, potassium metabisulfite, calcium propionate, sorbic acid, benzoic acid, propionic acid, acetic acid, lactic acid, tartaric acid, fumaric acid, malic acid, gluconic acid, natamycin, nisin, lysozyme, thymol, carvacrol, hexametaphosphate, sodium lactate, glycerol monolaurate, hydrogen peroxide, and combinations thereof.

18. The hydration composition of claim 2, wherein the glucose and the fructose ratio is about 1:1, wherein the working osmolality is about 210 to 268 mOsm/kg, and wherein the hydration composition has a total carbohydrate content in a range of about 6% to about 8% (w/v).

19. A method of providing hydration and fuel to a subject, the method comprising:
providing the subject the hydration composition of claim 1,
wherein, the hydration composition maintains hydration and provides fuel to the subject.

20. The method of claim 19, wherein providing the hydration composition maintains proper fluid balance and supports muscle function.

21. The method of claim 19, wherein the hydration composition is provided in an amount sufficient to offset the loss of water through sweating.

22. The method of claim 19, wherein the hydration composition is formulated to enhance fluid retention and sustain metabolic function in the subject.

23. The method of claim 19, wherein the hydration composition provides cellular uptake of fluids and provides immediate and sustained energy to the subject.

24. The method of claim 19, wherein the subject is engaged in physical exertion and the hydration composition provides sustained hydration and fuel while the subject is engaged in physical exertion.

25. The method of claim 19, wherein the hydration composition supports prolonged endurance and reduces a risk of dehydration-related fatigue.

26. The method of claim 19, wherein the subject is experiencing dehydration due to illness, medical treatment, or environmental factors.

27. The method of claim 19, wherein the hydration composition is formulated for a personalized use based on an individual athletic performance, a medical rehydration, an occupational hydration management, and a general wellness.

28. The method of claim 19, wherein the hydration composition enhances cellular ATP production efficiency to offset dehydration-induced metabolic slowdown.

29. The method of claim 19, wherein the hydration composition enhances evaporative cooling efficiency by dynamically adjusting hydration intake based on core temperature of the subject.

30. The method of claim 19, wherein the hydration composition enhances cellular glucose absorption via sodium-glucose co-transport mechanisms.
